(19) United States
(12) Patent Application Publication
(10) Pub. No.: US 2009/0239193 A1
(43) Pub. Date: Sep. 24, 2009

(54) Teeth protection device

(76) Inventor: Alison Rae Green, Punta Gorda, FL (US)

Correspondence Address: John Ruffini, 24037 Madaca Lane #103, Port Charlotte, FL, 33954, US

(21) Appl. No.: 12/077,963

(22) Filed: Mar. 24, 2008

(51) Int. Cl. A61C 5/14

(52) U.S. Cl. 433/136

(57) ABSTRACT

A protective shield is substantially preformed to fit within a mouth of a patient undergoing high or low intensity pulse light or laser treatment to prevent pain from developing the nerves or because of the presence of metal dental work. The shield will diffuse the laser beam to thereby lessen or prevent any impact on the nerves. The shield can be made of a plastic material such as Ether Polyurethane, Polyethylene Teraphthalate, Polyethalyne, and/or Polycarbonate.

### BACKGROUND OF THE INVENTION

The inventive concept is directed to a protection device for the teeth during a laser treatment or IPL. Laser light promotes healing in many conditions because it penetrates deep into the tissues, transforming a cell from an unhealthy and unstable condition. Laser or IPL is subjective to the person's pigmentation and/or skin color depending on the type of treatment being applied. Quantum therapy, for example, utilizes low-energy and electromagnetic radiation that has beneficial effects on both the intracellular and intercellular processes. Another known laser process is called Fraxel which is used to treat damaged and aging skin by harmlessly penetrating the outer layer of the skin. Side effects are minimal and are usually limited to a sunburn-like redness. Still, another low level laser treatment is known as TeraQuant which utilizes low-energy electromagnetic radiation. Another well known treatment of the skin is performed under the well known name of Palomar Medical Technologies. It is used, among others, as a fractional ablative and non-ablative skin resurfacing. The only known side effects of all of the above noted laser treatments are that the radiation rays impact on amalgam fillings in teeth or other metal dental work and can result in quite a painful experience. In many instances, teeth fillings contain metal substances which, when impacted by the radiation rays, tend to vibrate or cause heat conduction to the nerves to thereby cause the pain.

### BRIEF DESCRIPTION OF THE INVENTION

The inventive concept provides for a screen or a shield that will be placed into the mouth of a person undergoing radiation treatment or IPL. The shield results in the rays, which are penetrating through the skin including the lips and the cheeks of the person, to be diffused to thereby lose their impact on the teeth having the filling and/or other metal dental work.

The procedure is used in physicians offices, even if they have an asthetics department (or SPA) within the office. It is used for hair removal, hair folicle damage to stop regrowth, photo-facial to remove sun damage and age spots, resurfacing which removes wrinkles and skin tightening which shrinks pores. The shield may also be placed over any tattooed areas not wished to be exposed by the IPLs or laser.

### BRIEF DESCRIPTION OF THE DRAWINGS

FIG. 1 illustrates a cross section through the mouth of a person including a laser emitting hand piece;

FIG. 2 shows a top or a bottom view of a person's teeth being surrounded by a protective shield;

FIG. 3 shows a perspective view of the contour of the shield.

### DETAILED DESCRIPTION OF THE INVENTION

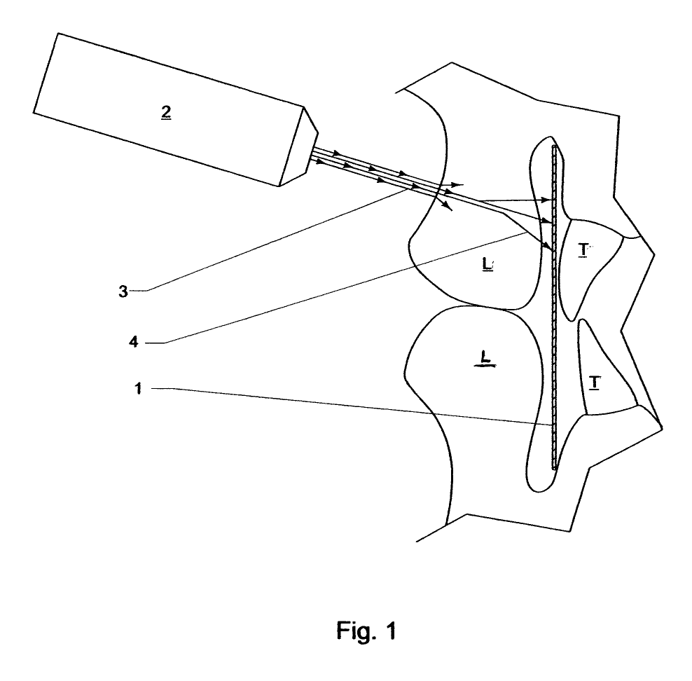

FIG. 1 shows a side view of a person's interior of a mouth including the teeth marked as T. The shield 1 is positioned in front of the teeth T but behind the lips P. The lips and the cheeks will hold the shield in place within the mouth during a laser or IPL treatment. The laser hand piece is shown at 2 which, when in use, will emit the rays or beams 3. The rays or beams 3 will penetrate through the lips P and the cheeks but will diffuse as soon as they hit the shield as is shown at 4. This diffusion will never hit the teeth or dental work thereby eliminating any experience of pain. The dental work may include implants which are placed over screws or pins placed in the roots of the teeth.

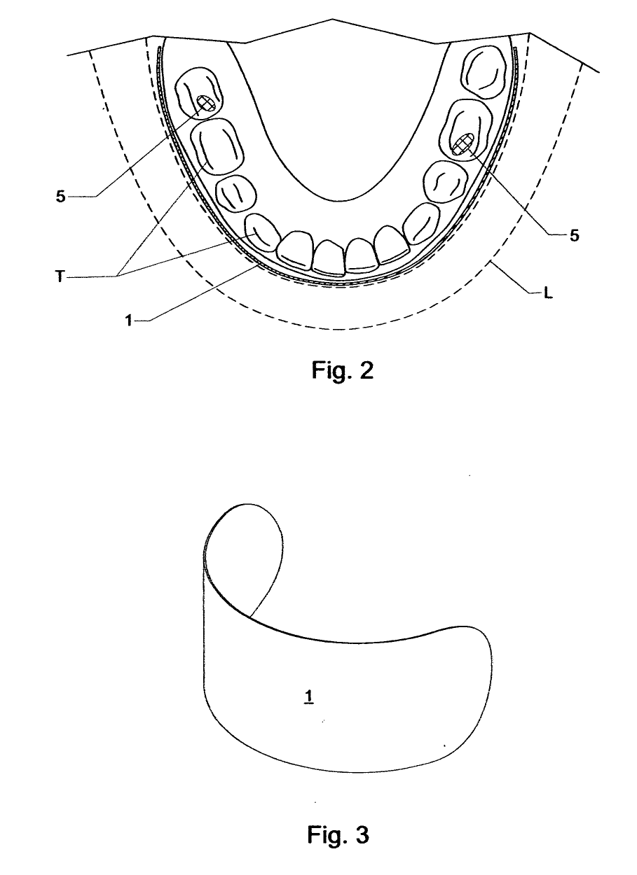

FIG. 2 is a top or a bottom view of the teeth T as they are situated within a mouth. The shield 1 can clearly be seen surrounding the teeth T. The numbers 5 and 6 represent fillings placed within the teeth which are now protected from any harmful rays from high or low levels of intense impulse lights. (I.P.L.) or laser rays or beams.

FIG. 3 represents the shield 1 itself as it may be preformed into a curved shape. This preformed shape is still flexible and may be compliant to be placed in many differently shaped mouths. The shield may also be used to cover other areas to be protected from the laser IPL, such as, brows, lips etc. including as a cover for tattoos and permanent make-up so as not to alter the color or remove the same. Also, it can be seen that there are no sharp edges on this preformed shield.

The shield may be manufactured from a plastic material such as polyurethane, Ether polyurethane, polyethylene terephthalate (PET), polyethylene (PE) or polycarbonate. Polycarbonate is preferred because it is used to make eye glasses because of its durability and high infractions because it bends light and, of course, it diffuses high and low intensity light and laser beams. It is still effective when made in thin sheets to thereby create its flexibility so it can be placed into differently shaped mouths.

What I claim is:

1. A shield to be placed within a mouth of a patient during high or low intensity light treatment to protect the nerves from conduction with metal dental work from inducing pain in a patient.

2. The shield of claim 1, wherein said shield is flexible to conform to differently mouths.

3. The shield of claim 2, wherein said shield is selected from the group of plastic materials consisting of Ether Polyurethane, Polyethylene Terephthalane, Polyathalene and polycarbonate.

4. The shield of claim 1, wherein said shield is preformed to substantially the shape of a mouth.
